(19) United States
(12) Patent Application Publication
(10) Pub. No.: US 2004/0010752 A1
(43) Pub. Date: Jan. 15, 2004

(54) System and method for filtering XML documents with XPath expressions

(75) Inventors: Chee-Yong Chan, Berkeley Heights, NJ (US); Pascal A. Felber, Lausanne (CH); Minos N. Garofalakis, Chatham Township, NJ (US); Rajeev Rastogi, Chatham, NJ (US)

Correspondence Address: HITT GAINES P.C., P.O. BOX 832570, RICHARDSON, TX, 75083, US

(73) Assignee: Lucent Technologies Inc., Murray Hill, NJ

(21) Appl. No.: 10/191,140

(22) Filed: Jul. 9, 2002

(51) Int. Cl. G06F 15/00

(52) U.S. Cl. 715/513

(57) ABSTRACT

A system for, and method of, filtering an XML document with XPath expressions and a selective data dissemination system incorporating the system or the method. In one embodiment, the filtering system includes: (1) a tree builder that builds a document data tree for the XML document and an XPath expression tree based on substrings in the XPath expressions and (2) a tree prober, associated with the tree builder, that employs the XPath expression tree to probe the document data tree and obtain matches with the substrings.

### TECHNICAL FIELD OF THE INVENTION

The present invention is directed, in general, to systems for processing markup languages and, more specifically, to a system and method for filtering Extensible Markup Language (XML) documents with XPath expressions.

### BACKGROUND OF THE INVENTION

The exploding volume of information (e.g., stock quotes, news reports, advertisements) made available on the Internet has fueled the development of a new generation of applications based on selective data dissemination, where specific data is selectively relayed to a large number (e.g., millions) of distributed clients. This trend has led to the emergence of novel middleware architectures that asynchronously propagate data from a set of publishers (i.e., data generators) to a large number of widely dispersed subscribers (i.e., data consumers) who have pre-registered their interest in specific information items (A. Carzaniga, D. Rosenblum and A. Wolf. “Design and Evaluation of a Wide-Area Event Notification Service,” ACM Transactions on Computer Systems, 19(3): 332-383, August 2001. In general, such publish-subscribe architectures are implemented using a set of networked servers that selectively propagate relevant messages to the consumer population, where message relevance is determined by subscriptions representing the consumers' interests in specific messages.

The majority of existing publish/subscribe systems have typically relied on simple subscription mechanisms, such as keyword or “bag of words” matching, or simple comparison predicates on attribute values. For example, prior art systems such as “Gryphon” (M. K. Aguilera, R. E. Strom, D. C. Sturman, M. Astley and T. D. Chandra, “Matching Events in a Content-based Subscription System” In Proc. of ACM PODC, pages 53-61, Atlanta, Ga., May 1999), “Siena” (Carzanaga, et al., supra), and “Elvin” (B. Segall, D. Arnold, J. Boot, M. Henderson and T. Phelps, “Content Based Routing with Elvin4,” In AUG2K, Canberra, Australia, June 2000, all incorporated herein by reference), all use filters in the form of a set of attributes and simple arithmetic or Boolean comparisons on the values of these attributes.

The recent emergence of XML (“Extensible Markup Language (XML) 1.0, 2^{nd} Edition,” http://www.w3.org/TR/REC-xml/, October 2000, incorporated herein by reference) as a standard for information exchange on the Internet has led to an increased interest in using more expressive subscription/filtering mechanisms that exploit both the structure and the content of published XML documents. In particular, the XPath language (“XML Path Language (Xpath) 1.0.” http://www.w3.org/TR/xpath/, November 1999, incorporated herein by reference), which is a World Wide Web Consortium (W3C) proposed standard for addressing parts of an XML document, has been adopted as a filter-specification language by a number of recent XML data dissemination systems (e.g., “XFilter” (M. Altinel and M. Franklin, “Efficient Filtering of XML Documents for Selective Dissemination of Information,” In Proc. Of VLDB, pages 53-64, September 2000) and Intel's NetStructure XML Accelerator (“Intel NetStructure XML Accelerators,” http://www.intel.com/netstructure/products/xml_accelerators.htm, 2000)).

Given the increased complexity of structural, XPath-based data filters, effectively identifying the subscriptions that match an incoming XML document poses a difficult and important research challenge. More specifically, the key problem faced in XPath-based data-dissemination systems can be abstracted as the following XPath Expression (XPE) Retrieval problem: “Given a large collection P of XPEs and an input XML document D, find the subset of XPEs in P that match D.”

Various work has been performed on the filtering of data using “flat patterns” in the form of conjunctions of simple predicates on data attributes, including research on rule/trigger processing systems (E. N. Hanson and M. Chaabouni and C. H. Kim and Y. W. Wang, “A Predicate Matching Algorithm for Database Rule Systems,” In Proc. Of ACM SIGMOD, pages 271-280, Atlantic City, N.J., May 1990; and E. N. Hanson, C. Carnes, L. Huang, M. Konyala, L. Noronha, S. Parthasarathy, J. B. Park and A. Vernon, “Scalable Trigger Processing,” In Proc. of IEEE ICDE, pages 266-275, Sydney, Australia, March 1999, both incorporated herein by reference) and publish-subscribe systems (Aguilera, et al., supra; F. Fabret. H. Jacobsen, F. Llirbat, K. Ross and D. Shasha, “Filtering Algorithms and Implementations for Very Fast Publish/Subscribe Systems,” In Proc. of ACM SIGMOD, pages 115-126, Santa Barbara, Calif., May 2001.; and B. Nguyen, S. Abiteboul, G. Cobena and M. Preda, “Monitoring XML data on the Web,” In Proc. of ACM SIGMOD, pages 437-448, Santa Barbara, Calif., May 2001, all incorporated herein by reference). However, for reasons that will be set forth in greater detail below, these prior art schemes are wasteful of computing resources. In contrast, the XTrie scheme of the present invention focuses on filtering XML documents based on tree patterns (based on XPath expressions), which demands far more sophisticated indexing techniques, since tree patterns consist of both data contents as well as structure.

Accordingly, what is needed in the art is a system and method for effectively addressing this problem.

### SUMMARY OF THE INVENTION

To address the above-discussed deficiencies of the prior art, the present invention provides a system for, and method of, filtering an XML document with XPath expressions and a selective data dissemination system incorporating the system or the method. In one embodiment, the filtering system includes: (1) a tree builder that builds a document data tree for the XML document and an XPath expression tree based on substrings in the XPath expressions and (2) a tree prober, associated with the tree builder, that employs the XPath expression tree to probe the document data tree and obtain matches with the substrings.

The present invention therefore introduces a novel index structure, termed XTrie, that supports the efficient filtering of XML documents based on XPath expressions. The XTrie index structure offers several novel features that make it especially attractive for large-scale publish/subscribe systems. First, XTrie is designed to support effective filtering based on complex XPath expressions (as opposed to simple, single-path specifications). Second, the XTrie structure and algorithms are designed to support both ordered and unordered matching of XML data. Third, by indexing on sequences of element names organized in a trie structure and using a sophisticated matching algorithm, XTrie is able to both reduce the number of unnecessary index probes as well as avoid redundant matchings, thereby providing extremely efficient filtering. The experimental results over a wide range of XML document and XPath expression workloads demonstrate that the XTrie index structure outperforms earlier approaches by wide margins.

In one embodiment of the present invention, the matches are ordered matches. The matches can alternatively be unordered.

In one embodiment of the present invention, the tree builder comprises an event-based parsing interface. Those skilled in the pertinent art are familiar with such interfaces and their advantageous use in parsing streaming data.

In one embodiment of the present invention, the substrings are minimal decompositions of the XPath expressions. However, the substrings may be non-minimal decompositions of the XPath expressions.

In one embodiment of the present invention, the tree prober parses the document data tree with the XPath expression tree to detect matching substrings in the XML document and iterates, for each of the matching substrings, through all instances of the matching substrings in the document data tree to determine whether the matching substrings are non-redundant. The present invention introduces a method of searching an XML document that carries out steps analogous to those performed by the tree prober of this embodiment.

In one embodiment of the present invention, the tree builder builds a substring table for the XPath expression tree. The structure and function of one embodiment of the substring table will be set forth in detail in the Detailed Description that follows.

In one embodiment of the present invention, the tree prober probes the substring table only for matching substrings that appear as a leaf substring in one of the XPath expressions. However, the tree prober may be more “eager” than this. Two embodiments, one “eager” and one “lazy,” will be set forth in greater detail below.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIGS. 1A and 1B together illustrate unordered and ordered matching in exemplary XML document trees;

FIGS. 2A-2C together illustrate substring decompositions in exemplary XPath expression trees;

FIG. 3 illustrates an exemplary XPath expression tree;

FIG. 4 illustrates an exemplary SEARCH software algorithm to search an XPath expression tree;

FIG. 5 illustrates an exemplary MATCH-SUBSTRING software algorithm to process a matched substring;

FIG. 6 illustrates an exemplary PROPAGATE-UPDATE software algorithm to update B whenever a non-redundant subtree-matching of a non-root substring is detected;

FIG. 7 illustrates an exemplary selective data dissemination system constructed according to the principles of the present invention; and

FIGS. 8A-8D together illustrate experimental pertaining to one embodiment of a system constructed according to the principles of the present invention.

### DETAILED DESCRIPTION

The key technique for expediting XPE retrieval is to construct an appropriate index structure on the given collection of XPE subscriptions. Since XPEs can, in general, represent structurally complex tree patterns, building index structures for efficient XPE retrieval is a non-trivial problem. Furthermore, simplistic approaches (e.g., building an index based solely on the element names contained in the XPEs) can result in very ineffective retrieval schemes that incur a lot of unnecessary checking of (irrelevant) XPE subscriptions.

As stated above, the present invention is directed, among other things, to a novel index structure, termed “XTrie,” that supports the efficient filtering of XML documents based on XPath expressions. The XTrie index structure offers several novel features that make it especially attractive for large-scale publish/subscribe systems.

First, XTrie is designed to support effective filtering based on complex XPath expressions (as opposed to simple, single-path specifications). Second, the XTrie structure and algorithms are designed to support both ordered and unordered matching of XML data. Note that ordered matching is an important requirement for many applications (e.g., document processing) that has typically been overlooked in existing data dissemination systems. Third, by indexing on sequences of element names (i.e., substrings) organized in a trie structure and using a sophisticated matching algorithm, XTrie is able to both reduce the number of unnecessary index probes as well as avoid redundant matchings, thereby providing extremely efficient filtering.

Indexing on a set of substrings (rather than individual element names) in the XPEs is an important aspect of the approach that enables both the number and the cost of the required index probes to be reduced or even minimized. The underlying realization is that a sequence of element names has a lower probability (compared to a single element name) of matching in an input document, resulting in fewer index probes. In addition, since fewer indexed XPEs are associated with a “longer” substring key, each index probe is likely to be less time-consuming, as well.

To support on-line filtering of streaming XML data, the illustrated embodiment of the XTrie indexing scheme of the present invention is based on the conventional, event-based SAX parsing interface (D. Megginson, “SAX: A Simple API for XML,” http://www.megginson.com/SAX/, incorporated herein by reference), to implement XML data filtering as the XML document is parsed. Alternatively, the DOM parsing interface (“Document Object Model (DOM) Level 1 Specification (Second Edition), Version 1.0,” http://www.w3.org/TR/REC-DOM-Level-1/, incorporated herein by reference) could be used. DOM requires a main-memory representation of the XML data tree to be built before filtering can commence. The only other convention SAX-based index structure for the XPE retrieval problem appears to be “XFilter” (Altinel, et al., supra), which relies on indexing the XPE element names using a hash table structure. By indexing on substrings rather than individual element names, our XTrie index provides a much more effective indexing mechanism than XFilter. A further limitation of XFilter is that its space requirement can grow to a very large size as an input document is parsed, which can also increase the filtering time significantly. Experimental results over a wide range of XML document and XPath expression workloads validate XTrie's operation, demonstrating that the XTrie index structure significantly outperforms XFilter (by factors of up to 4).

XPath Expressions (XPEs) and XPE-trees. An XML document comprises a hierarchically nested structure of elements, starting with a root element; sub-elements of an element can themselves be elements and can also contain character data (i.e., text) and attributes. Elements can be nested to any depth and the scope of an element in the XML document is defined by a start-tag and an end-tag. The Xpath language treats XML documents as a tree of nodes (corresponding to elements) and offers an expressive way to specify and select parts of this tree. XPath expressions (XPEs)are structural patterns that can be matched to nodes in the XML data tree. The evaluation of an XPE yields an object whose type can be a node-set, a boolean, a number, or a string. For the XPE retrieval problem, an XML document matches an XPE when the evaluation result is a non-empty node set.

The simplest form of XPEs specify a single-path pattern, which can be either an absolute path from the root of the document or a relative path from some known location (i.e., “context node”). A path pattern is a sequence of one or more “location steps.” In its basic form, a location step specifies a node name (i.e., an element name), and the hierarchical relationships between the nodes are specified using parent-child(“/”) operators (i.e., at adjacent levels) and ancestor-descendant(“//”) operators (i.e., separated by any number of levels). For example, the XPE /a/b//c selects all c element descendants of all b elements that are direct children of the root element a in the document. XPath also allows the use of a wildcard operator (“*”) to match any element name at a location step.

Each location step can also include one or more predicates to further refine the selected set of nodes. Predicate expressions are enclosed by “[” and “]” symbols. The predicates can be applied to the text or the attributes of the addressed elements, and may also include other path expressions. Any relative paths in a predicate expression are evaluated in the context of the element nodes addressed in the location step at which they appear. For example, the XPE /a[b[@x≧100]/c]/*/d specifies a tree pattern starting at the root element a with two child “branches” b/c and */d such that the element b has an attribute x with a value equal to or greater than 100.

The tree pattern specified by an XPE can be represented by an ordered rooted tree, where each node is labeled with an element name (prefixed by either “/” or “//” followed by an optional sequence of one or more “*/”). The ordering of the child nodes for each parent node is based on their order of appearance in the XPE. Such a tree representation of an XPE is referred to as an “XPE-tree.”

Unordered and Ordered XPE Matchings. Before describing the two modes of matching XPEs, some new definitions and notation should be introduced. Given two nodes ν and ν′ in a rooted tree T , ν “precedes” ν′ in a post-order traversal of T, denoted by ν [symbol] ₚₒₛₜ ν′, if ν is visited before ν′ in a post-order traversal of T.

Each node d in an XML document tree is associated with a level number, denoted by level(d), where level(d)=1 if d is the root element; otherwise, level(d)=level(d′)+1, where d′ is the parent node of d.

Each node t in an XPE-tree T is associated with a relative level (with respect to its parent node in T), which is defined to be at least k, denoted by relLevel(t)=[k,∞], if the label of t is prefixed with “//” followed by (k−1) “*”; otherwise, if the label of t is prefixed with “/” followed by (k−1) “*”, then the relative level of t is defined to be exactly k, denoted by relLevel(t)=[k, k].

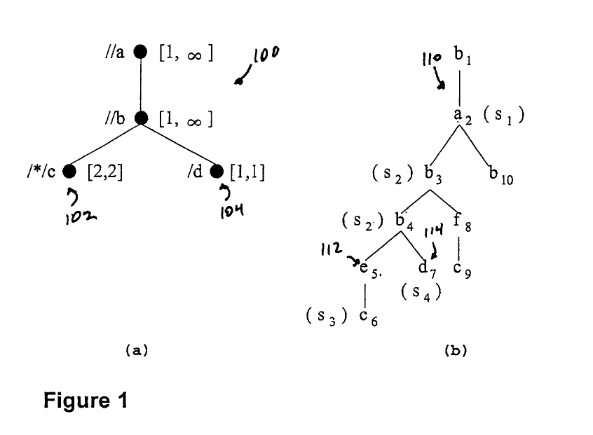

Consider an XPE-tree T with the set of nodes {t₁, t₂, . . . ,ₘ} and an XML document tree D. A node tᵢ in T “matches” at a node d in D if the element name of tᵢ is equal to that of d. In the unordered matching model, where T is treated as an unordered tree, T matches D if a set of m nodes {d₁,d₂, . . . ,dₘ} exists in D such that (1) for each node tᵢ in T, tᵢ matches at dᵢ, and (2) for each child node tⱼ of a node tᵢ in T, dⱼ is a descendant of dᵢ such that level(dⱼ)−level(dᵢ)εrelLevel(tⱼ). As an example, consider the XPE-tree T of p=//a//b[*/c]/d 100 in FIG. 1A, where the label and relative level of each node are indicated on its left and right, respectively; and the XML document tree D 110 in FIG. 1B, where the subscripts indicate the order in which the nodes are parsed (ignore parenthetical annotations for now). Note that T 100 matches D 110 with //a,//b,/*/c, and d matching at a₂, b₄, c₆, and d₇, respectively.

In addition to the model of unordered matchings, Xpath also allows the order of matching to be explicitly specified. Consider again the XPE-tree in FIG. 1A for p. If it is desired to indicate that the “branch” */C 102 must match in the document before the “branch” d 104, this can be expressed using the XPE p′=//a//b/*[following−sibling::d]/c. Referring again to FIG. 1, if the positions of the two subtrees rooted at e₅ 112 and d₇ 114 in D 110 are swapped, then p′ would not match D 110 while p would still match D 110. In the ordered matching model, where T 100 is treated as an ordered tree, T 100 matches D 110 if (1) T 100 matches D 110 in the unordered matching model, and (2) for each pair of child nodes tⱼ and tₖ of each internal node in T 100, tⱼ [symbol] ₚₒₛₜ tₖ in T iff dⱼ [symbol] ₚₒₛₜdₖ in D 110.

Note that hybrid matchings of XPEs, which involve both unordered as well as ordered matchings, are also possible. Due to space constraints, the present discussion shall focus on only ordered matchings of XPEs that do not contain any attributes in the rest of this paper. Details on handling attributes as well as unordered and hybrid matchings are given in C. Y. Chan, P. Felber, M. Garofalakis, and R. Rastogi, Efficient Filtering of XML Documents with XPath Expressions, Technical report, Bell Labs., June 2001 (incorporated herein by reference).

XPE Decompositions and Matchings

This section describes the mechanisms employed in the XTrie index for decomposing XPEs into sequences of XML element names (i.e., substrings) and defines several important concepts for matching based on substring trees that play a key role in the XTrie indexing structure and matching algorithms.

Substring Decompositions.

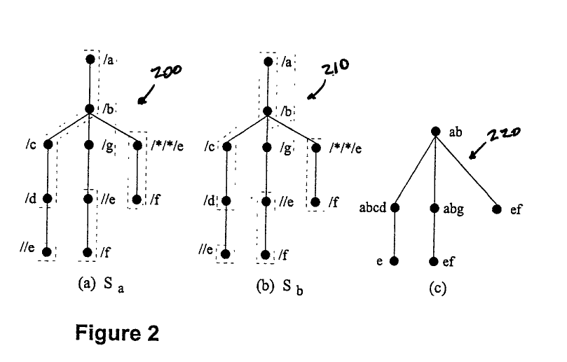

Given an XPE p, a sequence of element names s=t₁·t₂ . . . ·tₙ is defined to be a substring of p if s is equal to the concatenation of the element names of the nodes along a path <ν₁,ν₂, . . . νₙ> in the XPE-tree of p, such that each νᵢ is the parent node of νᵢ₊₁(1≦i<n) and the label of each νᵢ (except perhaps for ν₁) is prefixed only by “/” . In other words, each pair of consecutive element names in a substring of p is separated by a parent-child (“/”) operator. We use Path(s) to denote the path of nodes in the XPE-tree of p that defines the substring s. As an example, consider the XPE p=/a/b[c/d//e][g//e/f]//*/*/e/f 200 whose XPE-tree is depicted in FIG. 2A. The set of substrings of p 200 includes abg, bcd, ef and b; on the other hand abge, gef, and bef are not substrings of p 200, since they involve an intermediate element name (i.e., e) that is not prefixed by “/”.

A sequence of substrings S=<s₁,s₂, . . . ,sₙ> of an XPE p is said to be a “substring decomposition” of p 200 if each sᵢεS is a substring of p 200 and each node tⱼ in p's XPE-tree is contained in Path(sᵢ) for some sᵢεS. The ordering of the substrings in S is fixed based on the order in which they would be matched in an ordered matching of p 200; i.e., sᵢ should be matched before sᵢ₊₁. A substring decomposition S is a “minimal decomposition” of p if each substring sᵢ of S is of maximal length; that is, another longer substring in p's XPE-tree that contains sᵢ does not exist. A minimal decomposition of p 200 therefore comprises the smallest possible number of substrings among all possible decompositions of p 200. FIGS. 2A and B show two possible substring decompositions 200, 210, respectively, for the example XPE p 200, where each dashed region encloses a path of nodes defining a substring. Note that Sₐ is the (unique) minimal decomposition of p 200.

The XTrie index relies on substring decompositions for installing XPEs into the indexing structure. The choice of a specific class of substring decompositions impacts both the space and performance of the index. Though all substring decompositions fall within the broad scope of the present invention, minimal decompositions, in particular, have two important performance advantages.

First, since longer substrings have a lower probability of being matched in the input XML document, the maximal-length substrings chosen in a minimal decomposition generally result in fewer index probes. Second, since fewer XPEs are associated with a longer substring, the cost of each index probe is generally lower with minimal decompositions. On the other hand, using only a minimal decomposition for an XPE can result in problems when checking for an unordered matching. For example, consider again the minimal decomposition Sₐ in FIG. 2A, where s₁=abcd , s₂=e , s₃=abg, s₄=ef, and s₅=ef. Since “ab” is part of s₁ and s₃ but not part of s₅, for unordered matching, using only Sₐ would fail to detect a matching of p when s₅ matches after “ab” has been matched but before s₁ and s₃ are matched.

Intuitively, to avoid such problems, the minimal decomposition of an XPE should be enriched so that it “takes note” of the branching nodes in the XPE-tree. The XTrie index accomplishes this through the use of simple XPE decompositions. Formally, a substring decomposition S is said to be a simple decomposition of an XPE p 200 if S can be partitioned into two sequences S₁ and S₂, where: (1) S₁ is the minimal decomposition of p 200; and, (2) S₂ consists of one substring s for each branching node ν in p's XPE-tree, such that s is the maximal substring in p 200 with ν as its last node and s is not already listed in S₁. As an example, the decomposition S_{b} depicted in FIG. 2B is the simple decomposition of the example XPE p 200; note that S_{b} simply adds the substring ab (b is a branching node) to the minimal decomposition Sₐ. Also, note that, for a single-path XPE, its simple decomposition is equal to its minimal decomposition.

The substrings of the simple decomposition of pᵢ can be organized into a unique rooted tree, referred as the “substring-tree” of pᵢ, as follows. Let Sᵢ=<s_{i,1}s_{i,2}, . . . ,s_{i,|p}_{ᵢ}_{|}> denote the simple decomposition of pᵢ, where |pᵢ| denotes the number of substrings in the simple decomposition of pᵢ. Then, the “root” substring is s_{i,1}, and the “parent” substring of s_{i,j}, where j>1, is s_{i,k} (or equivalently, s_{i,j} is the “child” substring of s_{i,k} if either (1) Path(s_{i,k}) is a prefix of Path(s_{i,j}), or (2) the last node of Path(s_{i,k}) is the parent node of the first node of Path(s_{i,j}) in the XPE-tree of pᵢ. The ordering among sibling sub-strings is based on their ordering in Sᵢ. As an example, FIG. 2C shows the substring-tree for the simple decomposition in FIG. 2B. A substring that has no child substrings is called a leaf substring. A substring s_{i,j} is said to be a “descendant” of another substring s_{i,k}, if either s_{i,k} is the parent substring of s_{i,j}, or the parent substring of s_{i,j} is a descendant of s_{i,k}. Similarly, s_{i,k}, is said to be an “ancestor” of s_{i,j} if s_{i,j} is a descendant of s_{i,k}. Finally, the “rank” of a substring s_{i,j} is defined to be equal to k if s_{i,j} is the k^{th} child of its parent substring; the rank of the root substring is 1.

The notion of relative level that was defined for nodes in XPE-trees will now be extended to substrings. Informally, the relative level of a substring s refers to the relative difference in levels between the last elements of s and its parent substring in a matching. More formally, consider a substring s of an XPE p (with parent substring s′), and let t=<t₁,t₂, . . . ,tₙ> be the longest suffix of Path(s) such that t₁∉Path(s′). Let relLevel(tᵢ)=[lᵢ,uᵢ] for 1≦i≦n, and let k denote

$${\sum }_{i = 1}^{n} {l}_{i} .$$

Then the “relative level” of s is defined to be at least k, denoted by relLevel(s)=[k,∞], if max_{1≦i≦n}{uᵢ}=∞; otherwise, it is defined to be exactly k, denoted by relLevel(s)=[k,k].

Matching with Substrings.

Consider an XML document tree D, and an XPE pᵢ with XPE-tree Tᵢ and simple decomposition <s_{i,1},s_{i,2}, . . . ,s_{i|p}_{₁}_{|}>. Since each substring s_{i,j} corresponds to some path of nodes Path(s_{i,j}) in Tᵢ, the definition of matching for nodes can be extended to substrings as follows: s_{i,j} matches at a node d in D (or a matching of s_{i,j} occurs at d in D) if Path(s_{i,j}) matches D such that the last node of Path(s_{i,j}) matches at d. A matching of s_{i,j} at level l in D is said to occur if s_{i,j} matches at some node at level l in D.

As the nodes in D are parsed in a pre-order traversal (by the SAX parser), the ordered matching of pᵢ in D also progresses incrementally following a pre-order traversal of the substring-tree of pᵢ such that each substring s_{i,j} is matched before s_{i,k},k>j. Thus, to determine if pᵢ matches D, the “partial matchings” of pᵢ in D need to be tracked. However, since only whether or not pᵢ matches D is of interest, and not the actual number of match occurrences, “partial matchings” of pᵢ that are “redundant” can be ignored to improve the effectiveness of the filtering process.

The notions of partial and redundant matchings can now be formally defined. Given and XPE pᵢ and an XML document tree D, Mᵢ is defined to be a set of matchings (with respect to pᵢ and D ) if Mᵢ contains pairs of the form (s_{i,j},dⱼ), where s_{i,j} matches at dⱼ, and for each distinct pairs (s_{i,j},dⱼ), (s_{i,j′},d_{j′})εMᵢ,s_{i,j}≠s_{i,j′} and dⱼ≠d_{j′}. A partial matching of s_{i,j} at node dⱼ in D occurs if a set of matchings Mᵢ exists such that, for each 1≦k≦j, (1) (s_{i,k},dₖ)εMᵢ; and (2) for each child substring s_{i,k}, of s_{i,k},d_{k′} is a descendant of dₖ such that level(d_{k′})−level(dₖ)εrelLevel(s_{i,k′}). It follows that a (complete) matching of pᵢ in D occurs if a partial matching of s_{i,|p}_{ᵢ}_{|} exists at some node in D. A partial matching is represented by its set of matchings Mᵢ.

To define redundant matching, the notion of subtree-matching should first be introduced. A set of matchings Mᵢ is said to be a subtree-matching of s_{i,j} if Mᵢ is a partial matching of each descendant of s_{i,j}. Informally, a partial matching of s_{i,j} at a node d is considered “redundant” if a subtree-matching of s_{i,j} at some “earlier” node d′ (i.e., d′ [symbol] ₚₒₛₜ d in D) exists. Thus, all subsequent partial matchings that require the matching of s_{i,j} at d can be safely ignored without affecting the correctness of deciding whether or not pᵢ matches D. More precisely, a “partial matching” of s_{i,j} at dⱼ (represented by Mᵢ) where s_{i,k} is either s_{i,j} itself or an ancestor of s_{i,j}, such that (1) (s_{i,j},d_{j′})εMᵢ′ and d_{j′} post dⱼ in D; and (2) if s_{i,k} is not the root substring of pᵢ, then (s_{i,k′},d_{k′})εMᵢ∩Mᵢ′, where s_{i,k′} is the parent substring of s_{i,k}. Otherwise, Mᵢ is said to be a “non-redundant matching” of s_{i,j}.

Consider again the XPE p and XML document D 110 illustrated in FIG. 1, where the four substrings in the simple decomposition of p are: s₁=a, s₂=b, s₃=c, and s₄=bd. The parenthetical annotation “(sⱼ)” besides a node dᵢ in D 110 means that a non-redundant matching of sⱼ at dᵢ occurs when dᵢ is parsed in D 110. Thus p matches D 110. Both the partial matchings of s₃ at c₉ and s₂ at b₁₀ are redundant. Observe that a non-redundant matching could later become redundant as more nodes in the document tree are parsed; in particular, the non-redundant matching of s₂ at b₃ becomes redundant after d₇ is parsed.

The Xtrie Indexing Scheme

In this section, an Xtrie indexing scheme for filtering XML documents based on XPEs carried out according to the principles of the present invention will be introduced. Only ordered matchings will be discussed. The details for unordered and hybrid matchings can be found in Chan, et al., supra.

The Index Structure.

Let P={p₁,p₂, . . . ,pₙ} denote the set of XPEs being indexed, and S denote the set of distinct substrings derived from all the simple decompositions of the XPEs in P. An Xtrie index consists of two key components: (1) a Trie (D. Knuth, “The Art of Computer Programming: Sorting and Searching,” volume 3, chapter 6.3. Addison Wesley, second edition, 1998, incorporated herein by reference) (denoted by T) constructed on S to facilitate detection of substring matchings in the input XML data; and, (2) a Substring-Table (denoted by ST) that stores information about each substring of each XPE in P. The information in ST is used to check for partial matchings. Each of these two Xtrie components will now be described in detail.

The Substring-Table.

The Substring-Table ST contains one row for each substring of each indexed XPE; i.e., Σ_{pεP}|p| rows exist in ST with each row corresponding to some s_{i,j}. The rows in ST are physically clustered in terms of the XPEs such that the substrings belonging to an XPE p are stored in consecutive rows ordered based on the simple decomposition of p. The order of the XPEs in ST is arbitrary. Since each row r in ST corresponds to some substring, for convenience, the notation r_{i,j} denotes the row in ST that corresponds to the substring s_{i,j}.

To facilitate locating all XPEs that contain some substring, the rows in ST are also logically partitioned into |S| disjoint blocks, such that each block contains all the rows that correspond to the same substring. This substring-based partitioning of the rows in ST is achieved by chaining the rows within each block using a singly linked list, giving a total of |S| singly linked lists in ST (with one list for each distinct substring in S). The rows within each linked list are partially ordered, such that if rows r_{i,j} and r_{i,k} belong to the same linked list, then r_{i,k} precedes r_{i,j} in the linked list if j<k This is required to ensure correctness under the ordered matching model (Chan, et al., supra).

Each row in ST (corresponding to some substring s_{i,j}) is a 5-tuple (ParentRow, RelLevel, Rank, NumChild, Next), where:

ParentRow refers to the row number of the tuple in ST corresponding to the parent substring of s_{i,j}. (ParentRow=0 if s_{i,j} is a root substring.)

RelLevel is the relative level of s_{i,j} (i.e., relLevel(s_{i,j})) .

Rank is the rank of s_{i,j} (i.e., Rank=k if s_{i,j} is the k^{th} child substring of its parent substring).

NumChild is the total number of child substrings of s_{i,j}.

Next, which is a “pointer” for a singly linked list, is the row number of the next tuple in ST that belongs to the same logical block as the current row. If the current row is the last row in the linked list, then Next=0.

The Trie.

The trie T is a rooted tree constructed from the set of distinct substrings S, where each edge in T is labeled with some element name. Each node N in T is associated with a label, denoted by label(N), which is the string formed by concatenating the edge labels along the path from the root node of T to node N; the label of the root node is an empty string. T is constructed such that for each sεS, a unique node N exists in T such that label(N)=s; and for each leaf node N in T, label(N)εS. In addition to the pointers to nodes at the next level of the trie, each node N in T has two special pointers:

The Substring pointer (denoted by α(N)) points to some row in ST (i.e., α(N) is a row number) as follows: if label(N)εS, then α(N) points to the first row of the linked list associated with substring label(N) otherwise, α(N)=0.

The Max-suffix pointer (denoted by β(N)) points to some internal node in T and its purpose is to ensure the correctness of the matching algorithm. Specifically, β(N)=N′ if label(N′) is the longest proper suffix of label(N) among all the internal nodes in T; if N′ does not exist, then β(N) points to the root node of T.

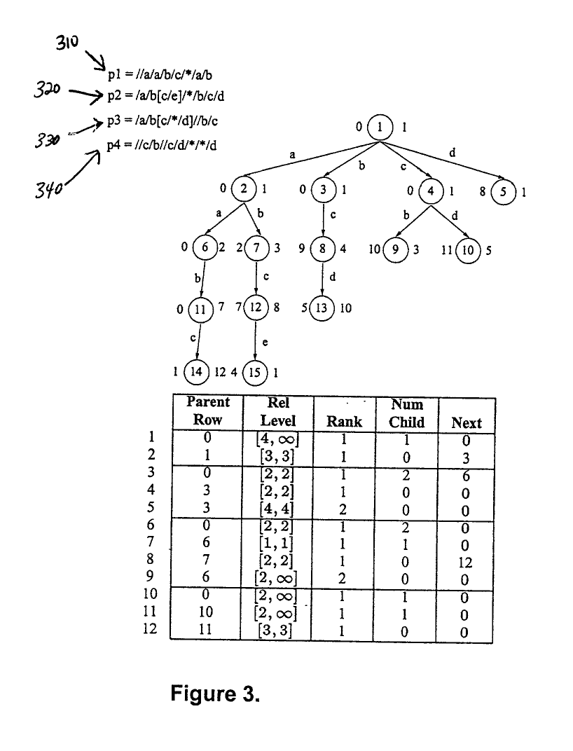

FIG. 3 depicts the XTrie index structures for a set of four XPEs P={p₁,p₂,p₃,p₄} 310, 320, 330, 340, where their respective simple decompositions are as follows: S₁=<aabc,ab>, S₂=<ab,abce,bcd>, S₃=<ab,abc,d,bc>, and S₄=<cb,cd,d>. The number within each trie node N represents the node's identifier; and the values of α(N) and β(N) are shown to the left and right of N, respectively.

The XTrie Matching Algorithm.

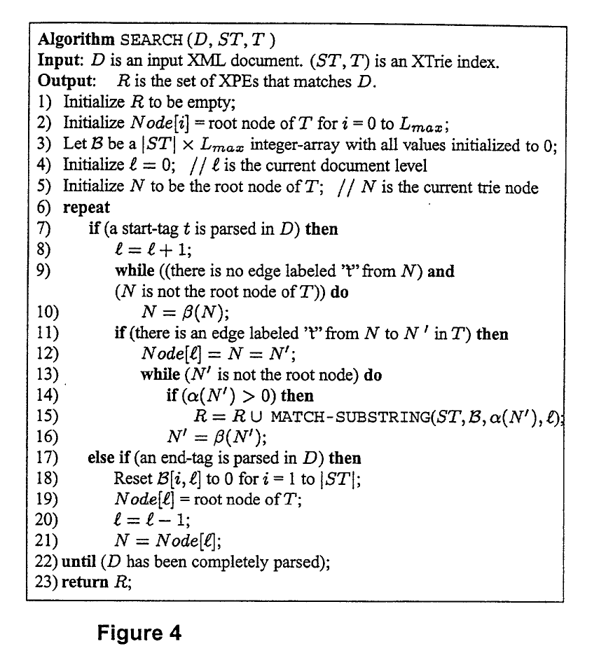

The XTrie indexing scheme is designed to support on-line filtering of streaming XML data and is based on the SAX event-based interface that reports parsing events. FIG. 4 shows the search procedure for the XTrie, which accepts as input an XML document D and an XTrie index (ST,T), processes the parsing events generated by D, and returns the identifiers of all the matching XPEs in the index.

The basic idea of the search algorithm is as follows. The trie T is used to detect the occurrence of matching substrings as the input document is parsed. For each matching substring s detected, we iterate through all the instances of s in the indexed XPEs (by traversing the appropriate linked list of rows in the substring-table ST associated with s) to check if the matched substring s corresponds to any non-redundant matching. Since the information stored in ST is static, some additional dynamic run-time information should advantageously be maintained to ensure that for non-redundant matchings are sought.

This run-time information is maintained in the form of a two-dimensional integer-array B of size |ST|×Lₘₐₓ, where |ST| denotes the number of rows in the substring-table ST, and Lₘₐₓ is the maximum number of levels in an XML document. B[r_{i,j,}l]=n,n >0, if a non-redundant matching of s_{i,j}(represented by M) at level l exists such that the n^{th} child substring of s_{i,j} is the leftmost child substring of s_{i,j} for which a subtree-matching has not yet been detected (i.e., M is a subtree-matching of the (n−1)^{th} child substring of s_{i,j} if n>1). Each B[r_{i,j},l] is initialized to 0, and is incremented to 1 after a non-redundant matching of s_{i,j} at level l is detected. As more substring matchings are detected, the value of B[r_{i,j},l] is incremented from n to n+1,n>1, when the matching M also becomes a subtree-matching of the n^{th} child substring of s_{i,j}. The value of B[r_{i,j},l] is reset to 0 when the end-tag corresponding to the begin-tag at level l is parsed. Note that since B is a large sparse array, its implementation can be optimized to minimize space (e.g., using linked lists).

To understand how B is used to detect non-redundant matchings, suppose that a matching of substring s_{i,j} at level l has been detected, and s_{i,j} is the n^{th} child substring of s_{i,k}. This matching is a partial matching of s_{i,j} if a matching of s_{i,k} exists at level l′ such that l−l′εrelLevel(s_{i,j}) and B[r_{i,k},l′]≧n. If, in addition, the value of B[r_{i,k},l′] is exactly n, then this partial matching is non-redundant; otherwise, it is redundant and it can safely be ignored. We know that an XPE pᵢ matches the input document when B[r_{i,l}l]=m+1 for some value of l, where m is the number of child substrings of the root substring s_{i,l}.

The XTrie SEARCH algorithm (depicted in FIG. 4) begins by initializing the search node N to be the root node of the trie T (line 5). For each start-tag t encountered, if an edge out of N with the label t (to another trie node N′ in T) exists, the search continues on node N′. For each trie node N′ visited, a matching substring (corresponding to label(N′)) is detected if α(N′) ≠0; in this case, Algorithm MATCH-SUBSTRING is invoked to process the matching substring using the substring table ST. Furthermore, for each trie node N′ visited, we also need to check for other potential matching substrings that are suffixes of label(N′); this is achieved by using the max-suffix pointer (i.e., β(N′)) in line 16. On the other hand, if no edge is out of a node N with the current tag t, this means that the concatenation of label(N) and t is not a matching substring. Therefore, we need to check for other potential matching substrings, which are formed by the concatenation of some suffix of label(N) and t, by using the max-suffix pointer in line 10. For each end-tag t encountered (corresponding to some start-tag at level l), the run-time information B is updated by resetting B[r,l] to 0 for all rows r (line 18), and the search node is re-initialized to its previous location before the tag t was encountered (line 19). This is achieved by using an array Node to keep track of the location of the search node at each document level (line 12).

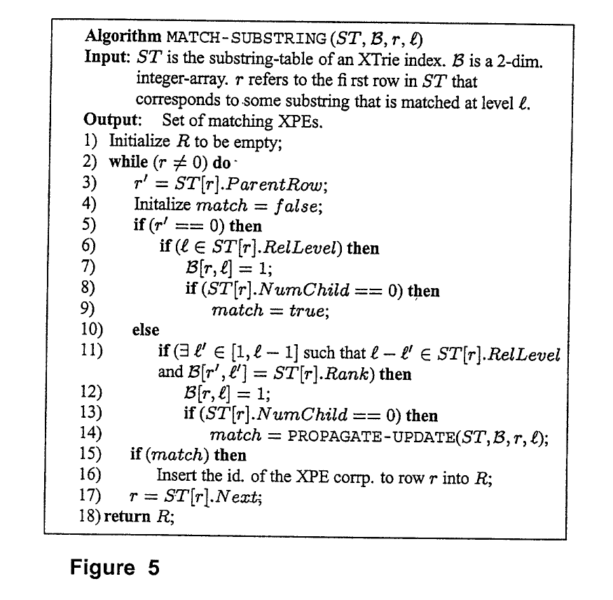

Algorithm MATCH-SUBSTRING (FIG. 5) is invoked when a substring s (matching at level l ) is detected. The algorithm checks for non-redundant matchings of s, updates the run-time information B, and returns the identifiers of all the matching XPEs that have s as their last substring. More specifically, the algorithm iterates through each instance of s in ST (i.e., each row in the linked list associated with s) to check for non-redundant matchings of s. Two scenarios exist for the instance of the matching substring (say, s_{i,j}) corresponding to row r. For the special case where s_{i,j} is a root substring (lines 5-9), if its positional constraint is satisfied (line 6), then the matching is a partial matching (and obviously non-redundant, since it is a root substring) and B[r,l] is updated to 1. If, in addition, s_{i,j} is a leaf substring, then a matching of pᵢ occurs (line 9). For the general case where s_{i,j} is a non-root substring (lines 10-14), if a non-redundant matching of s_{i,j} exists (line 11), then B[r,l] is updated to 1. If, in addition, s_{i,j} is a leaf substring, then Algorithm PROPAGATE-UPDATE is called to update the run-time information array B and check for a matching of pᵢ. It should be pointed out that, since multiple matches of the same XPE are usually not of interest, unnecessary processing and checking in MATCH-SUBSTRING for XPEs that have already been matched can advantageously be eliminated. This can be achieved by using a bit-mask (consisting of one bit per XPE); details of this additional filtering have been omitted from FIG. 5, since those skilled in the pertinent art understand how bit-masking is performed.

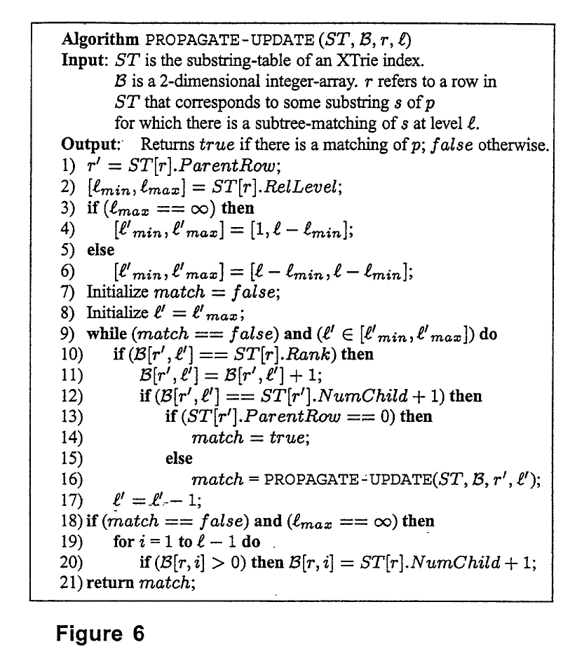

Algorithm PROPAGATE-UPDATE (depicted in FIG. 6) is used to update B whenever a non-redundant subtree-matching of some non-root substring (S_{i,j} matching at level l corresponding to row r in ST) is detected. Algorithm PROPAGATE-UPDATE iterates through each matching of its parent substring (at level l′ε[lₘᵢₙ′,lₘₐₓ′]) and updates its B entry if the matching forms a non-redundant matching of s_{i,j}. If this matching is also a subtree-matching for the parent substring of s_{i,j} (line 12), then two cases should be considered. If the parent substring is a root substring (line 13), then a matching of pᵢhas been found; otherwise, the update propagation of the B entries should be recursed for the ancestor substrings of s_{i,j} as well (line 16). The algorithm returns true if a matching of pᵢ has been detected; otherwise, if it is possible to have multiple matchings of the parent substring of s_{i,j} (i.e., relLevel(s_{i,j})=[lₘᵢₙ,∞] for some lₘᵢₙ), then to avoid any subsequent redundant matchings of descendants of s_{i,j}. the Algorithm PROPAGATE-UPDATE updates the B entries of all the earlier matchings of s_{i,j} (lines 18 to 20), and returns false.

The space requirement of the XTrie index is dominated by the total number of substrings in P; that is, the space complexity is

$$O ( {\sum }_{i = 1}^{\vert P \vert} \vert {p}_{i} \vert ) ,$$

where |pᵢ| denotes the number of the substrings in the simple decomposition of pᵢ. To analyze the time complexity, let P denote the length of the longest root-to-leaf path in the trie T, L denote the maximum length of a linked list in ST, and H denote the maximum height of a substring-tree. The complexity of Algorithm PROPAGATE-UPDATE is O(H Lₘₐₓ). Since Algorithm MATCH-SUBSTRING makes at most L calls to Algorithm PROPAGATE-UPDATE, the complexity of Algorithm MATCH-SUBSTRING is O(L H Lₘₐₓ). For each start-tag in the input document, Algorithm SEARCH makes at most P calls to Algorithm MATCH-SUBSTRING; thus, the complexity of processing each start-tag is O(PLHLₘₐₓ).

This section will be concluded by briefly describing an optimized variant of XTrie, which will be referred to as “Lazy Xtrie.” In contrast to above variant of XTrie (referred to from this point forward as “Eager XTrie”), which probes the substring-table ST for every matching substring detected in the input document, Lazy XTrie postpones the probing of ST, such that the substring-table is only probed for a matching substring s if s appears as a leaf substring in some XPE; otherwise, for a matching non-leaf substring s, Lazy XTrie only updates information about the level at which s is matched in the input document. Thus, Lazy XTrie minimizes the number of unnecessary index probes at the expense of a slightly higher cost for each probe due to the additional processing required to check for matchings of the ancestor substrings of the matched leaf substring. The details of Lazy XTrie are given in (Chan, et al., supra).

Related Work

As stated in the Background of the Invention, various work has been performed on the filtering of data using “flat patterns” in the form of conjunctions of simple predicates on data attributes, including research on rule/trigger processing systems (e.g., the two Hanson, et al. schemes, supra) and publish-subscribe systems (Aguilera, et al., supra; Fabret, et al., supra; and Nguyen, et al., supra). In contrast, the XTrie scheme of the present invention focuses on filtering XML documents based on tree patterns (based on XPath expressions), which demands far more sophisticated indexing techniques, since tree patterns consist of both data contents as well as structure.

While XFilter (Altinel, et al., supra) is designed for filtering XML documents with XPath expressions, the XTrie index is based on decomposing tree patterns into collections of substrings (i.e., sequences of element names) and indexing them using a trie. XFilter treats each tree pattern as a set of finite state automata, with each automaton responsible for the matching of some path in the tree pattern. The collection of automata for all the tree patterns is indexed using a hash table on the single element names (i.e., automata transitions).

XTrie is more space-efficient than XFilter, since the space cost of XTrie is dominated by the number of substrings in each tree pattern, while the space cost of XFilter is dominated by the number of element names in each tree pattern. By indexing on substrings instead of single element names, the substring-table entries in XTrie are also probed less often than the hash table entries in XFilter. Furthermore, while XTrie ignores partial matchings of tree patterns that are redundant, XFilter keeps tracks of all instances of partially matched tree patterns, which results in more processing overhead.

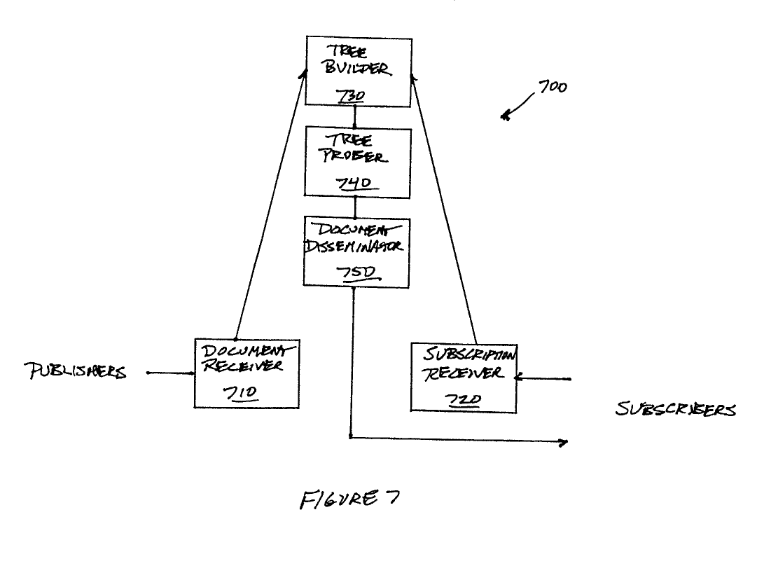

Turning now to FIG. 7, illustrated is an exemplary selective data dissemination system, generally designated 700, constructed according to the principles of the present invention. The system 700 includes a document receiver 710. The document receiver 710 is adapted to receive XML documents from a plurality of publishers (not shown). The system 700 further includes a subscription receiver 720. The subscription receiver 720 is adapted to receive words of interest from a plurality of subscribers (not shown). The words are received already encapsulated in XPath expressions or are encapsulated by the subscription receiver 720. The primary mission of the system 700 is to disseminate XML documents to the plurality of subscribers based on the words of interest thus encapsulated.

The system 700 further includes a tree builder 730. The tree builder 730 builds a document data tree for the XML documents and further builds an XPath expression tree (and, in the illustrated embodiment, a related substring table) based on substrings in the XPath expressions.

The system 700 further includes a tree prober 740. The tree prober 740 employs the XPath expression tree to probe the document data tree and obtain matches with the substrings.

As stated above, the matches determine which subscribers are sent which XML documents. Accordingly, the system 700 further includes a document disseminator 750. The document disseminator 750 selectively disseminates the XML documents to the plurality of subsribers based on the matches.

Experimental Evaluation

To determine the effectiveness of XTrie, its performance is compared to XFilter. Results indicate that XTrie is between two and four times faster than XFilter for single-path XPEs.

XML Documents.

Similar to Altinel, et al. (supra), the NITF (News Industry Text Format) DTD (R. Cover “The SGML/XML Web Page,” http://www.oasis.open.org/cover/sgml-xml.html, December 1999, incorporated herein by reference) was used to generate the XML document data set. The NITF DTD (version 2.5) contains 123 elements with 513 attributes. The data set of XML documents is generated using IBM′ s commercially available XML Generator tool (A. Diaz and D. Lovell, “XML Generator,” http://www.alphaworks.ibm.com/tech/xmlgenerator, September 1999, incorporated herein by reference). Three sets of 250 XML documents with similar characteristics were generated. These sets correspond to different sizes of document: small, medium and large, with an average of 20, 100, and 1000 pairs of tags, respectively.

XPath Expressions.

An XPath expression generator was implemented that takes a DTD as input and creates a set of valid XPath expressions (with no duplicates) based on the following set of six input parameters.

The parameter P controls the cardinality of the set of indexed XPEs (ranging from 10,000 to 500,000).

The parameter L controls the “depth” of the XPEs in terms of the maximum number of levels (ranging from 10 to 30). The parameter p_{w}(p_{d}) controls the probability (ranging from 0 to 0.5) of having a wildcard “/*” (descendant “//”) operator at each node.

The parameter p_{b} controls how “bushy” the XPE-trees of the XPEs are (ranging from 0 to 0.1); a value of 0 generates only single-path XPEs, while a higher value increases the number of branches in the XPE-trees.

The parameter θ (ranging from 0 to 1) controls the skewness of the Zipf distribution (G. Zipf. Human Behaviour and Principle of Least Effort. Addison-Wesley, Cambridge, Mass., 1949, incorporated herein by reference) used for selecting element names, where a value of 0 corresponds to a uniform distribution and a higher value corresponds to a more skewed distribution.

Algorithms.

The performance of four algorithms is compared: (1) XFilter, (2) XFilter with “list balance” optimization (Altinel, et al., supra), which is denoted by XFilter-LB, (3) Eager XTrie and (4) Lazy Xtrie. Note that the prefiltering optimization (Altinel, et al., supra) was not applied to XFilter, because this optimization is orthogonal to the index approach, and is applicable to XTrie as well. All the algorithms were implemented in C++ and compiled using GNU C++ version 2.95.3. Experiments were conducted on a Sun Ultra-250 with 512 MB of main memory running Solaris 2.7. All the index structures were resident in main-memory for all the experiments.

For each input XML document, the total filtering time, which includes the CPU time to parse the input document, probe and update the index, and report the matched expressions, was measured. The performance metric for each category of documents (small, medium, or large) is the average filtering time over the set of 250 XML documents for that category. The SAX parser of the Apache Foundation (“Xerces C++ Parser,” http://xml.apache.org, 2001, incorporated herein by reference) was used for parsing XML documents. The average times for parsing a small, medium, and large document were 2.8 ms, 11.9 ms, 105.3 ms, respectively.

Experimental Results.

Experimental results are shown in FIGS. 7a-7d, where the base case uses the following parameter values: medium data set, P=10,000, L=20, p_{w}=0.1, p_{d}=0.1, p_{b}=0, and θ=0.

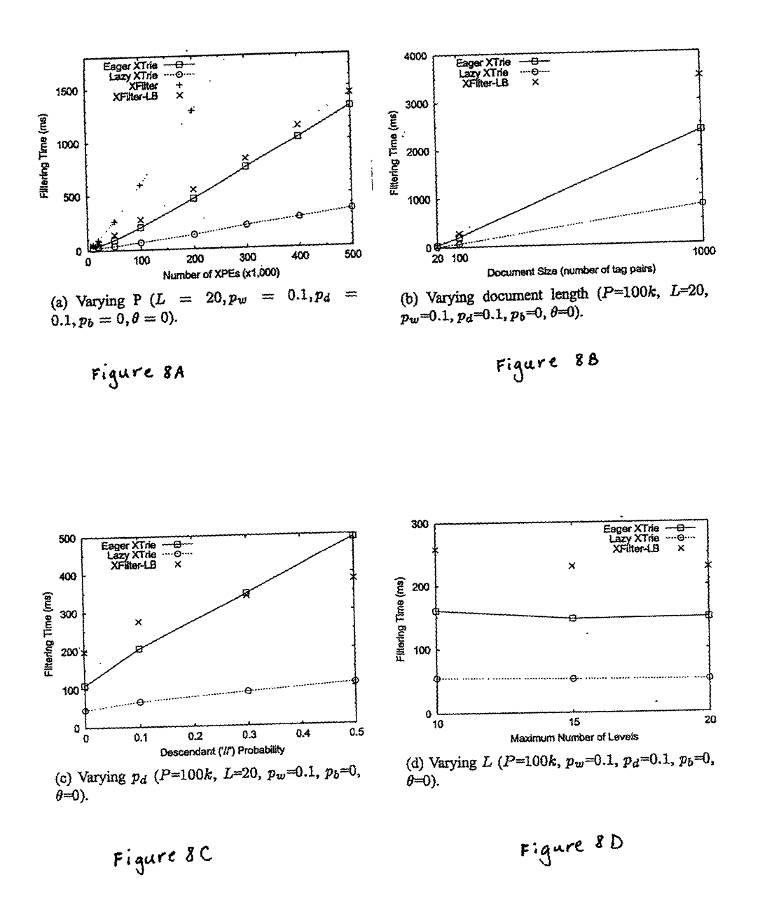

FIG. 8A compares the scalability of the algorithms as a function of P, the size of the set of indexed XPEs. The results show that the filtering time increases almost linearly with P, with Lazy XTrie being the fastest algorithm, which outperforms XFilter-LB by a factor of between 2 and 4. Eager XTrie performs slightly better than XFilter-LB, and XFilter performs the worst. Note that since the performance of XFilter is always much worse than XFilter-LB, we omit XFilter from subsequent graphs.

FIG. 8B compares the scalability of the algorithms as a function of the size of the XML documents (in terms of the number of tag-pairs). The results clearly show that the filtering time increases linearly with the document size for all the algorithms.

FIG. 8C shows that increasing the probability of descendant operators in the XPEs (i.e., p_{d}) increases the filtering time of all the algorithms. For the XTrie algorithms, this is because having more descendant operators in a XPE is likely to result in a larger number of shorter substrings in its simple decomposition, which not only increases the number of entries in the substring-table but also leads to more matchings in the trie (due to shorter substrings). For the XFilter-LB algorithm, having more descendant operators in the XPEs translates to more instances of partially matched expressions thereby resulting in more processing overhead.

Finally, FIG. 8D compares the effect of the “depth” of the XPEs on the performance of the filtering algorithms. The graphs show that the performance of all the algorithms improves slightly as the depth of the XPEs increases. This is because tree patterns with longer “branches” are more selective resulting in fewer matches. More experimental results are given in (Altinel, et al., supra).

Memory usage of both XTrie and XFilter are also compared; the experimental results indicate that XTrie is more space efficient. For instance, for the experiment in FIG. 8A with 500,000 XPEs, XTrie required approximately 18 MB of memory, while XFilter required 26 MB.

Conclusions

From the above, it is apparent that XTrie supports the efficient filtering of streaming XML documents based on XPath expressions. The XTrie index of the present invention offers several novel features that make it especially attractive for large-scale publish/subscribe systems. First, the XTrie is designed to support effective filtering based on complex XPath expressions (as opposed to simple, single-path specifications). Second, the XTrie structure and algorithms are designed to support both ordered and unordered matching of XML data. Third, by indexing on sequences of XML element names (i.e., substrings) organized in a trie structure and using a sophisticated matching algorithm, XTrie is able to both reduce the number of unnecessary index probes as well as avoid redundant matchings, thereby providing extremely efficient filtering. Experimental results over a wide range of XML document and XPath expression workloads have clearly demonstrated the benefits of the approach of the present invention, showing that the XTrie index consistently outperforms earlier approaches by wide margins.

Although the present invention has been described in detail, those skilled in the art should understand that they can make various changes, substitutions and alterations herein without departing from the spirit and scope of the invention in its broadest form.

What is claimed is:

1. A system for filtering an XML document with XPath expressions, comprising:
a tree builder that builds a document data tree for said XML document and an XPath expression tree based on substrings in said XPath expressions; and
a tree prober, associated with said tree builder, that employs said XPath expression tree to probe said document data tree and obtain matches with said substrings.

2. The system as recited in claim 1 wherein said matches are ordered matches.

3. The system as recited in claim 1 wherein said tree builder comprises an event-based parsing interface.

4. The system as recited in claim 1 wherein said substrings are minimal decompositions of said XPath expressions.

5. The system as recited in claim 1 wherein said tree prober parses said document data tree with said XPath expression tree to detect matching substrings in said XML document and iterates, for each of said matching substrings, through all instances of said matching substrings in said document data tree to determine whether said matching substrings are non-redundant.

6. The system as recited in claim 1 wherein said tree builder builds a substring table for said XPath expression tree.

7. The system as recited in claim 1 wherein said tree prober probes said substring table only for matching substrings that appear as a leaf substring in one of said XPath expressions.

8. A method of searching an XML document, comprising:
building an XPath expression tree based on substrings in XPath expressions;
parsing said XML document with said XPath expression tree to detect matching substrings in said XML document; and
iterating, for each of said matching substrings, through all instances of said matching substrings in said XML document to determine whether said matching substrings are non-redundant.

9. The method as recited in claim 8 wherein said instances are ordered matches.

10. The method as recited in claim 8 wherein said parsing is carried out with an event-based parsing interface.

11. The method as recited in claim 8 wherein said substrings are minimal decompositions of said XPath expressions.

12. The method as recited in claim 8 further comprising building a substring table for said XPath expression tree.

13. The method as recited in claim 12 wherein said probing comprises probing said substring table only for matching substrings that appear as a leaf substring in one of said XPath expressions.

14. A selective data dissemination system, comprising:
a document receiver for receiving XML documents from a plurality of publishers;
a subscription receiver for receiving words of interest from a plurality of subscribers, said words being encapsulable in XPath expressions;
a tree builder that builds a document data tree for said XML document and an XPath expression tree based on substrings in said XPath expressions;
a tree prober that employs said XPath expression tree to probe said document data tree and obtain matches with said substrings; and
a document disseminator that selectively disseminates said XML documents to said plurality of subsribers based on said matches.

15. The system as recited in claim 14 wherein said matches are ordered matches.

16. The system as recited in claim 14 wherein said tree builder comprises an event-based parsing interface.

17. The system as recited in claim 14 wherein said substrings are minimal decompositions of said XPath expressions.

18. The system as recited in claim 14 wherein said tree prober parses said document data tree with said XPath expression tree to detect matching substrings in said XML document and iterates, for each of said matching substrings, through all instances of said matching substrings in said document data tree to determine whether said matching substrings are non-redundant.

19. The system as recited in claim 14 wherein said tree builder builds a substring table for said XPath expression tree.

20. The system as recited in claim 14 wherein said tree prober probes said substring table only for matching substrings that appear as a leaf substring in one of said XPath expressions.
